(19) United States
(12) Patent Application Publication
(10) Pub. No.: US 2016/0059677 A1
(43) Pub. Date: Mar. 3, 2016

(54) VEHICLE DOOR

(71) Applicant: HONDA MOTOR CO., LTD., Tokyo (JP)

(72) Inventors: Shouji Yamazaki, Saitama (JP); Hiroto Sugiyama, Saitama (JP); Takeshi Abe, Saitama (JP)

(21) Appl. No.: 14/781,654

(22) PCT Filed: Mar. 20, 2014
(86) PCT No.: PCT/JP2014/057862

§ 371 Date: Oct. 1, 2015

(30) Foreign Application Priority Data
Apr. 3, 2013 (JP) 2013-077977

(51) Int. Cl. B60J 5/04

(52) U.S. Cl. CPC B60J 5/0429; B60J 5/0444

(57) ABSTRACT

A vehicle door is provided with a door that opens and closes a door opening in the vehicle and a door beam that is provided inside the door. The door beam is provided with: joining points that are joined to the door; a fundamental cross-section edge that extends in the direction of extension of the door beam, on the outside of the joining points in the width direction (up-down direction) of the door beam; an extension section that protrudes outward from the fundamental cross-section edge; and a locating hole that is used for positioning when joining the door beam to the door. The locating hole is formed in the extension section.

### TECHNICAL FIELD

The present invention relates to a vehicle door having a door beam provided inside.

### BACKGROUND ART

Generally, a reinforcing door beam is provided inside a vehicle door, joined to the door with welding means such as spot welding, or mechanical joining means such as bolts and nuts. As the form of joining the door beam with the welding means inside the door, for example, there is known a door beam structure of a vehicle disclosed in Patent Literature 1.

Patent Literature 1 discloses manufacturing by press-molding the door beam to be provided inside the door, thereby making it possible to obtain the door beam which is light in weight and has a complicated shape. Also, Patent Literature 1 discloses forming a locating hole for positioning the door beam when mounting the door beam on the door with spot welding.

FIGS. 6A to 6C are views illustrating a rear end of a conventional door beam described in Patent Literature 1, in which FIG. 6A is a schematic view of the relevant part illustrating an arranged state of a locating hole, FIG. 6B is a schematic view of the relevant part illustrating an arranged state of a locating hole in a door beam having a rear end with a wider width, and FIG. 6C is a stress distribution diagram illustrating distribution of the stress applied to the locating hole.

As illustrated in FIGS. 6A and 6B, a conventional press-molded door beam 100, 200 includes a plurality of joining points 120, 220 provided at the ends in the front-rear direction thereof, which are used to join the door beam 100, 200 to an inner panel of the door with spot welding or the like. When joining the door beam 100, 200 to the inner panel, a locating hole 110, 210 formed near the joining points 120, 220 is used to position the door beam 100, 200 at a predetermined position on the inner panel, thereby accurately mounting the door beam 100, 200 on the predetermined position.

The locating hole 110, 210 is formed within the region defined by a so-called fundamental cross-section edge 130, 230 in which the joining points 120, 220 are provided, in the width direction (up-down direction) of the door beam 100, 200.

### CITATION LIST

### Patent Literature

Patent Literature 1: Japanese Patent Publication No. 4316561

### SUMMARY OF THE INVENTION

### Technical Problem

However, in the vehicle door including the door beam 100, 200 such as illustrated in Patent Literature 1 and FIGS. 6A and 6B, the locating hole 110, 210 is formed within the region defined by the fundamental cross-section edge 130, 230 of the door beam 100, 200 in which the joining points 120, 220 lie. That is, the locating hole 110, 210 is formed in the region which is a vehicle body part close to the door and the joining points 120, 220 and to which collision load having been propagated to the door beam 100, 200 at vehicle collision is propagated.

Consequently, at the vehicle collision, the door beam 100, 200 starts bending deformation as illustrated in FIG. 6C, and when tension other than the bending moment acts on the cross-section edge, stress concentration is generated at the locating hole 110, 210. This has resulted in a problem that withstanding impact force of the door beam 100, 200 is decreased.

In view of this, the present invention makes it an object thereof to provide a vehicle door including a door beam having a locating hole capable of suppressing a decrease in withstanding impact force.

### Solution to Problem

As means for solving the above problem, the present invention provides a vehicle door including: a door which opens and closes a door opening in the vehicle; and a door beam which is provided inside the door, the door beam including: joining points which are joined to the door; a fundamental cross-section edge which extends in a direction of extension of the door beam, on the outside of the joining points in a width direction (up-down direction) of the door beam; an extension section which protrudes outward from the fundamental cross-section edge; and a locating hole which is used for positioning when joining the door beam to the door, wherein the locating hole is formed in the extension section.

Herein, the fundamental cross-section edge will be described with reference to FIG. 2, FIG. 3, FIG. 5B, FIG. 6A and FIG. 6B. As illustrated in FIG. 6A, where the width in the up-down direction of the door beam 100 is not changed along an outer circumference of the door beam 100, the fundamental cross-section edge means upper and lower edges of the cross-section in itself (fundamental cross-section edge 130). As illustrated in FIG. 6B, where the door beam 200 includes a section 231 having a wider width and a section 232 having a narrower width in the up-down direction along the outer circumference thereof, the fundamental cross-section edge means upper and lower edges extending from the section 231 having a wider width on the end side toward the section 232 having a narrower width on the central part side (fundamental cross-section edge 230).

Moreover, as illustrated in FIG. 2, FIG. 3 and FIG. 5B, where an extension section 3j, 3Aj, 3Cj is formed which protrudes outward from a base section 3n, 3An, 3Cn on the outer periphery in the up-down direction, the fundamental cross-section edge means upper and lower edges of a door beam 3, 3A, 3C exclusive of the extension section 3j, 3Aj, 3Cj (fundamental cross-section edge 3i, 3Ai, 3Ci).

According to this configuration, the locating hole is formed in the extension section protruding outward from the fundamental cross-section edge of the door beam and thus the vehicle door makes it possible, when the vehicle (own vehicle) collides with another vehicle or the like, to avoid collision load from being exerted on the locating hole, because the locating hole lies in the outside of the fundamental cross-section region which greatly contributes to transmission of the collision load to the locating hole. As a result, the door beam makes it possible to suppress a decrease in withstanding impact force even where the locating hole is formed, because stress concentration is not generated at the locating hole.

Moreover, preferably, the joining points are joined to the door in a thickness direction of the door, the extension section includes a bend section which is bent in the thickness direction of the door, and the bend section includes a second joining point which is joined to the door in a width direction of the door.

According to this configuration, the door beam can be joined to the door with a simple structure without providing any section of a special shape in the door beam, because the joining points are joined to the door in the door thickness direction perpendicular to the extension direction of the door beam (door width direction).

Also, the door beam can be prevented from being displaced in the door thickness direction and the joining points can be prevented from being detached from the door in the door thickness direction, because the door beam has the extension section and the bend section and thus can be joined to the door in the direction perpendicular to the joining direction of the second joining point and the joining points.

Moreover, a degree of freedom of the shape of the door beam can be improved, because the joining point is formed at a position other than the fundamental cross-section region and thus influence to be exerted on performance and strength of the door beam is made little.

Furthermore, the door beam makes it possible to use the extension section for providing the locating hole, to form the bend section for providing the second joining point which is joined to the door in the door width direction. As a result, the structure of the door beam is simplified and thus increases in weight and cost can be suppressed.

Moreover, preferably, the extension section includes a base section which extends outward from the fundamental cross-section edge, and a projection section which is formed to extend from the base section to be away from the fundamental cross-section edge, and the bend section is formed in the projection section.

According to this configuration, the door beam makes it possible, by bending or inclining the projection section, to easily place the second joining point at a position which is distanced from the fundamental cross-section edge in the door thickness direction, because the projection section is arranged away from the fundamental cross-section edge.

Moreover, even if there is variability in the shape size when forming the door beam, the door beam makes it possible to allow the joining points and the second joining point to be joined to the door at the right positions, because the variability in the shape size can be absorbed by the portion where the fundamental cross-section edge and the projection section are away from each other.

Moreover, preferably, the locating hole is formed in the base section.

According to this configuration, when the projection section is subjected to external force to bend, the door beam makes it possible to suppress a decrease in positioning accuracy to improve the positioning accuracy, because the locating hole is provided in the base section adjacent to the fundamental cross-section edge.

Also, the present invention provides, as one aspect thereof, a vehicle door including: a door which opens and closes a door opening in the vehicle; and a door beam which is provided inside the door, the door beam including: a plurality of front side joining points which are formed on a front end of the door beam and joined to the door; a plurality of rear side joining points which are formed on a rear end of the door beam and joined to the door; and a locating hole which is used for positioning when joining the door beam to the door, wherein the locating hole is formed on the outside of the outermost lines of action in the width direction of the door beam, of the lines of action of a tensile load which connect the front side joining points with the rear side joining points, the tensile load being given to the door beam in the front-rear direction.

According to this configuration, the locating hole is formed on the outside of the lines of action of tensile load in the door beam and thus the vehicle door makes it possible, when the tensile load is given to the door beam, to provide the locating hole at a position on which the tensile load (stress concentration) can be avoided from being exerted. Consequently, even where the locating hole is formed in the door beam, withstanding impact force can be suppressed from decreasing.

### Advantageous Effects of the Invention

The present invention allows a vehicle door to be provided which includes a door beam having a locating hole capable of suppressing a decrease in withstanding impact force.

### BRIEF DESCRIPTION OF DRAWINGS

FIG. 1 is a schematic side view illustrating an internal structure of a vehicle door according to an embodiment of the present invention.

FIG. 2 is an enlarged schematic perspective view of the relevant part of a door beam, illustrating a mounted state of a front end of the door beam.

FIG. 3 is an enlarged schematic perspective view of the relevant part of a door beam, illustrating one modification of the vehicle door according to the embodiment of the present invention.

FIG. 4 is a view illustrating one modification of the vehicle door according to the embodiment of the present invention, and is an enlarged schematic transverse sectional view of the relevant part of the door beam, illustrating a mounted state of a rear end of the door beam.

FIGS. 5A and 5B are views illustrating another modification of the vehicle door according to the embodiment of the present invention, in which FIG. 5A is a schematic view of the relevant part illustrating a door beam having a constant width in the up-down direction, and FIG. 5B is a schematic view of the relevant part illustrating a door beam having a wider section and a narrower section in width in the up-down direction.

FIGS. 6A to 6C are views illustrating a conventional door beam described in Patent Literature 1, in which FIG. 6A is a schematic view of the relevant part illustrating an arranged state of a locating hole and joining points; FIG. 6B is a schematic view of the relevant part illustrating an arranged state of a locating hole and joining points in a door beam having a rear end with a wider width; and FIG. 6C is a stress distribution diagram illustrating distribution of the stress applied to the locating hole.

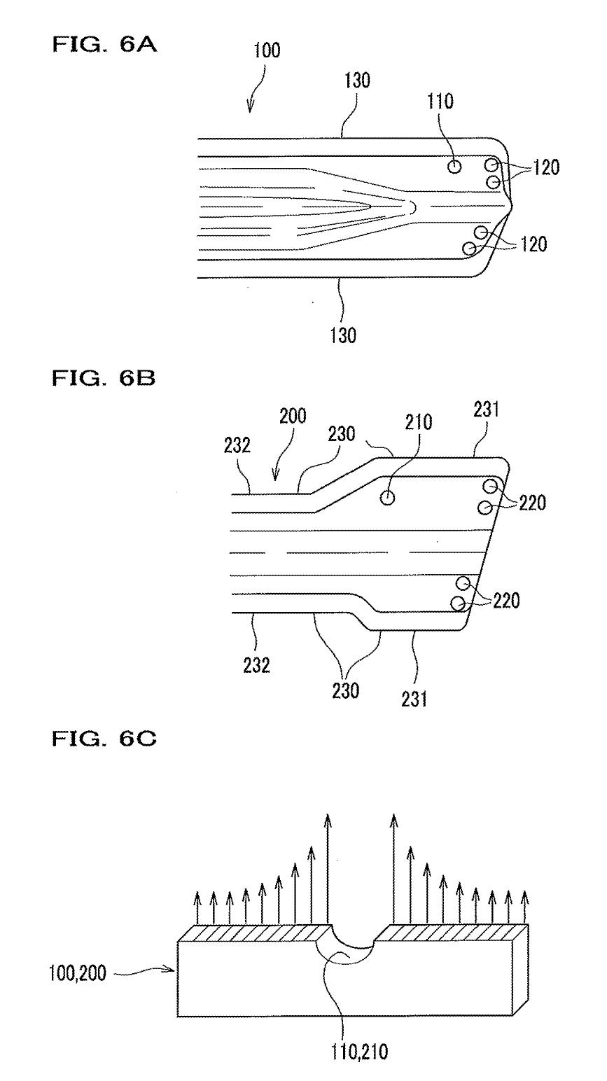

### DESCRIPTION OF EMBODIMENTS

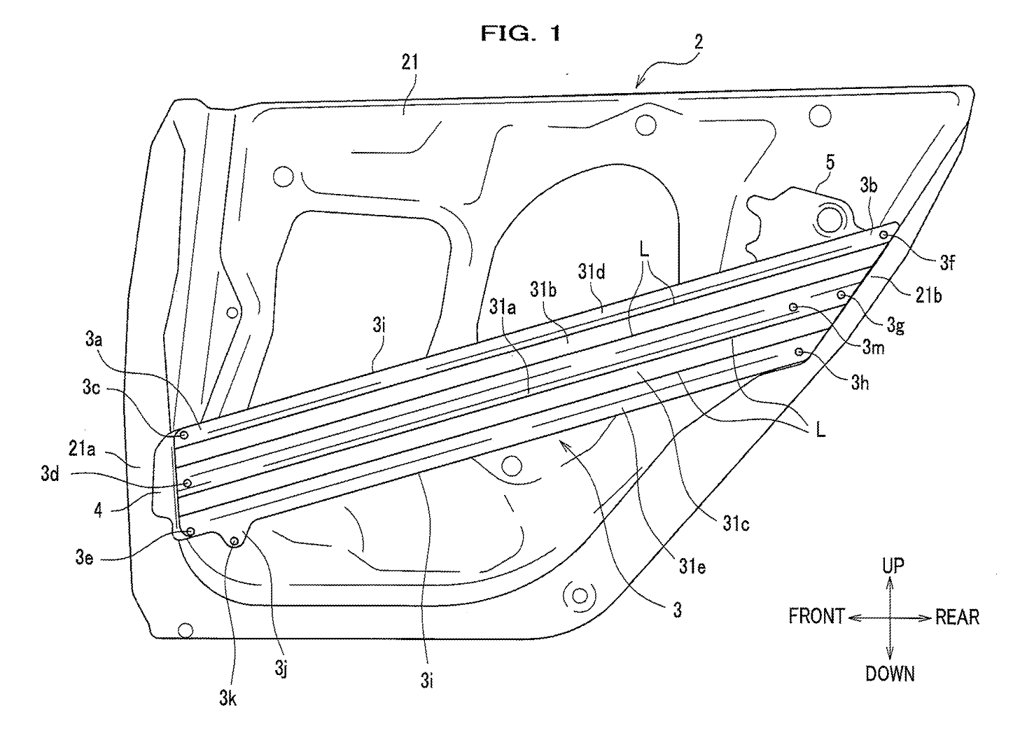

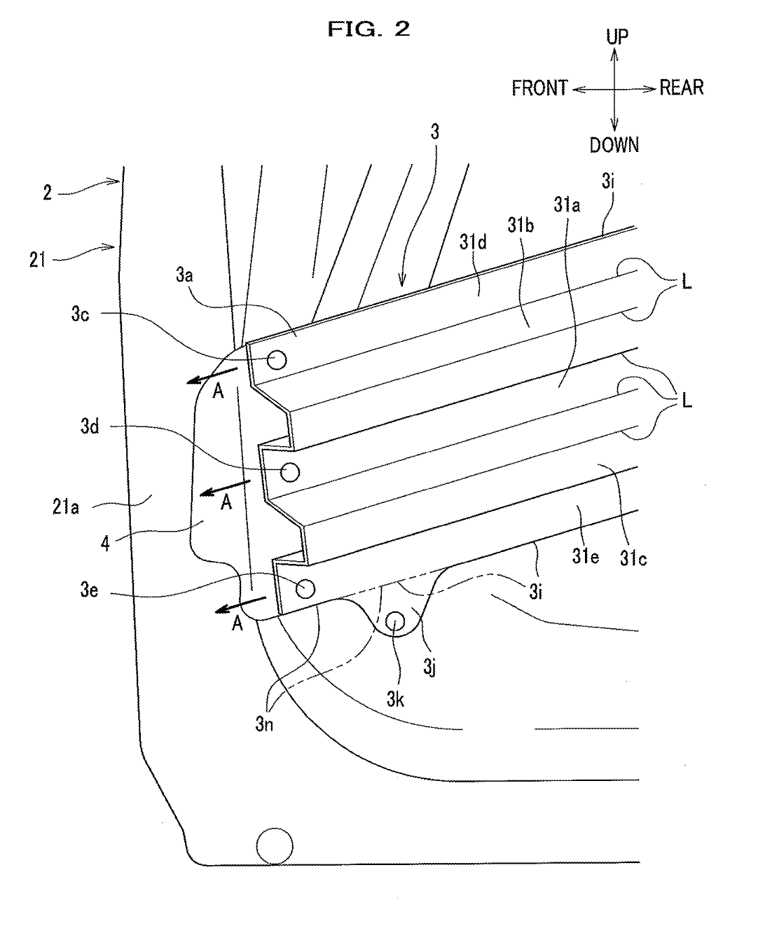

Hereinafter, a vehicle door according to an embodiment of the present invention will be described with reference to FIG. 1 and FIG. 2.

Note that the description will be given, defining a traveling direction of the vehicle as “front”, a retreat direction of the vehicle as “rear”, a vertical upper side of the vehicle as “up”, a vertical lower side of the vehicle as “down”, and a width direction of the vehicle as “right” and “left”.

### <<Configuration of Vehicle>>

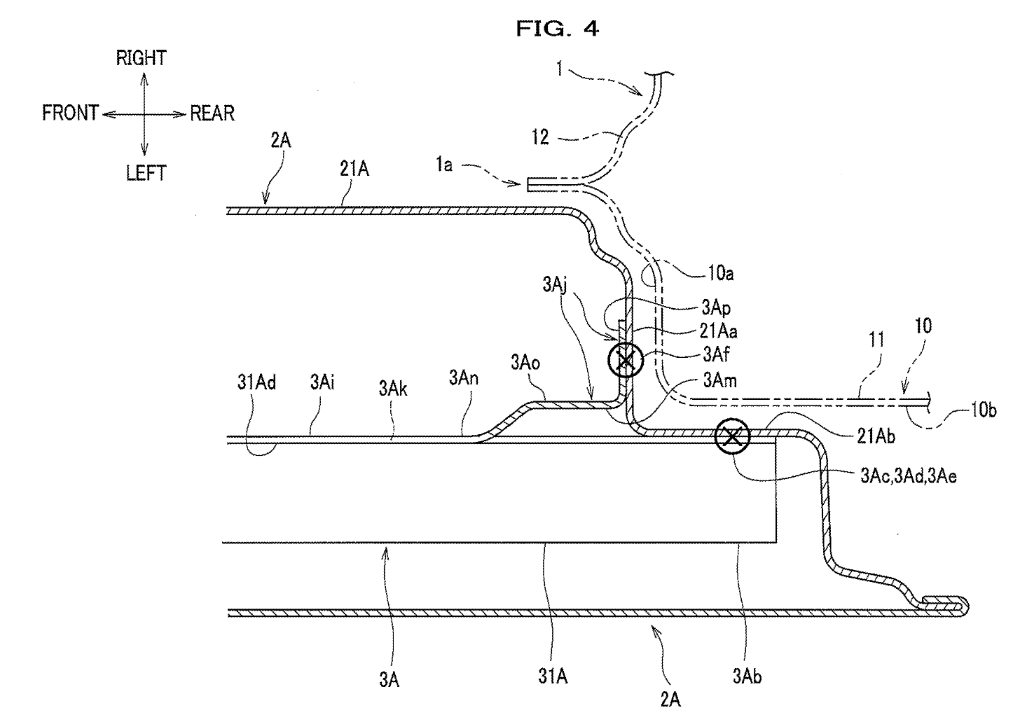

Firstly, description will be given of the vehicle to which the present invention is applied, prior to giving description of the vehicle door according to the embodiment of the present invention. As long as the vehicle is an automobile including a door 2 having a door beam 3 provided inside, forms and types thereof are not particularly limited. Hereinafter, the present invention will be described, taking the case of an automobile for example which includes the door 2 composed of a rear side door on the side part of a vehicle body 1 (see FIG. 4).

### <<Configuration of Vehicle Body>>

On the vehicle body 1 (see FIG. 4), a door opening 1a (see FIG. 4) is formed for providing a plurality of doors 2, for example, on the right and left side parts, respectively. Since the vehicle body 1 is formed in a bilaterally symmetric shape, the vehicle body side part on the left side will be hereinafter described and description on the vehicle body side part on the right side will be omitted.

On the vehicle body side part, for example, a front pillar, a front pillar lower, a center pillar and a rear pillar not shown in the figure, respectively, are provided to extend in the up-down direction, respectively. Moreover, on the vehicle body side part, a roof rail and a side sill are provided to extend in the front-rear direction, respectively. The door opening 1a (see FIG. 4) is formed to be a quadrangular opening defined by the center pillar, the rear pillar, the roof rail and the side sill.

### <<Configuration of Door>>

As illustrated in FIG. 1, the door 2 is a door body which opens and closes the door opening 1a (see FIG. 4). The door 2 is composed of, for example, a hinge-type door, a slide-type door, or a gull wing-type door which is disposed on the right and left lateral sides of the vehicle body 1. As long as the door 2 is one having the door beam 3, forms thereof are not particularly limited. Description will be given below, by way of example, of a rear side door which is provided with a hinge to open backward and disposed on the left side of the rear seat.

The door 2 includes an inner panel 21 which is provided inside the vehicle interior and constituting the door body, an outer panel (not shown) which is provided outside the vehicle interior opposite to the inner panel 21, the door beam 3 provided on the inner panel 21, a hinge member (not shown) for rotatably mounting the door 2 on the vehicle body, a bracket 4 which is provided on the front end of the door beam 3, a door lock device 5 for locking and unlocking of the door 2, a lining (not shown) which is provided inside the vehicle interior on the side of the inner panel 21, a window device (not shown) which is provided in the inner panel 21 and moves up and down windowpanes, an inside handle which is inserted from the outer panel to be secured to the lining, electrical components such as the window device, harnesses and the like, and a casing of rubber which is provided on the entire circumference of the door 2.

### <Configuration of Inner Panel>

The inner panel 21 is a door inner constituting a framework of the door 2 and is composed of, for example, a rolled steel plate formed in a nearly quadrangular shape. A peripheral part of the outer panel (not shown) is mounted with hemming and welding on a peripheral part of the inner panel 21. The front end side of the inner panel 21 is connected to be freely opened and closed to the center pillar (not shown) through a pair of hinge members provided in the up-down direction. The rear end side of the inner panel 21 allows a door closed-state to be held by the door lock device 5. Beam mounting sections 21a, 21b on which the door beam 3 for reinforcing the door 2 is provided are formed on a side close to the downside of the front end of the inner panel 21 and on a side close to the upside of the rear end of the inner panel 21.

### <Configuration of Outer Panel>

The outer panel not shown in the figure is a door skin disposed outside the door 2 and is formed by, for example, stamping a rolled steel plate. A door handle (not shown) is provided near the rear end side of the outer panel.

### <<Configuration of Door Beam>>

As illustrated in FIG. 1, the door beam 3 is a reinforcing member which is provided in a slanted state in a frontward descending manner along the front-rear direction inside the door 2, and is formed by stamping a beam body 31 comprised of one rolled steel plate. Formed on the door beam 3 are joining points 3c-3h joined to the door 2, a so-called fundamental cross-section edge 3i, an extension section 3j protruding outward from the fundamental cross-section edge 3i, a locating hole 3k for positioning of the door beam 3, a door lock device mounting hole 3m, a concave section 31a provided to extend in the longitudinal direction, convex sections 31b, 31c formed up and down along the concave section 31a, and flange sections 31d, 31e formed on upper and lower edges of the door beam 3.

The door beam 3 is comprised of an elongated rolled steel plate which includes the concave section 31a formed in the central part along the beam body 31 extending in the extension direction, the convex sections 31b, 31c formed along the concave section 31a up and down the concave section 31a, and the flange sections 31d, 31e formed along the upper and lower outsides of the convex sections 31b, 31c. The joining points 3c, 3d, 3e, the extension section 3j and the locating hole 3k are formed on a front end 3a of the door beam 3, and the joining points 3f, 3g, 3h, and the door lock device mounting hole 3m are formed on a rear end 3b of the door beam 3. The front end 3a of the door beam 3 is secured through the bracket 4 to the inner panel 21 by spot-welding the joining points 3c, 3d, 3e to the downside of the front end of the inner panel 21 and on a side close to the upside of the rear end of the inner panel 21. The rear end 3b of the door beam 3 is secured to the inner panel 21 by spot-welding the joining points 3f, 3g, 3h to the upside of the rear end of the inner panel 21.

As illustrated in FIG. 2, the joining point 3c is arranged on the front end 3a of the upper flange section 31d in the region defined by the fundamental cross-section edge 3i, 3i of the door beam 3. The joining point 3c is a spot at which the front end 3a of the upper flange section 31d is joined through the bracket 4 to the front side beam mounting section 21a of the inner panel 21.

The joining point 3d is arranged on the front end 3a of the concave section 31a in the region defined by the fundamental cross-section edge 3i, 3i of the door beam 3. The joining point 3d is a spot at which the front end 3a of the concave section 31a is joined through the bracket 4 to the front side beam mounting section 21a of the inner panel 21.

The joining point 3e is arranged on the front end 3a of the lower flange section 31e in the region defined by the fundamental cross-section edge 3i, 3i of the door beam 3. The joining point 3e is a spot at which the front end 3a of the lower flange section 31e is joined through the bracket 4 to the front side beam mounting section 21a of the inner panel 21.

As illustrated in FIG. 1, the joining point 3f is arranged on the rear end 3b of the upper flange section 31d in the region defined by the fundamental cross-section edge 3i, 3i of the door beam 3. The joining point 3f is a spot at which the rear end 3b of the upper flange section 31d is joined to the rear side beam mounting section 21b of the inner panel 21.

The joining point 3g is arranged on the rear end 3b of the concave section 31a in the region defined by the fundamental cross-section edge 3i, 3i of the door beam 3. The joining point 3g is a spot at which the rear end 3b of the concave section 31a is joined to the rear side beam mounting section 21b of the inner panel 21.

The joining point 3h is arranged on the rear end 3b of the lower flange section 31e in the region defined by the fundamental cross-section edge 3i, 3i of the door beam 3. The joining point 3h is a spot at which the rear end 3b of the lower flange section 31e is joined to the rear side beam mounting section 21b of the inner panel 21.

As illustrated in FIG. 2, the fundamental cross-section edge 3i means upper and lower edges of the door beam 3 extending in the extension direction, on the outside of the joining points 3c-3h in the width direction (up-down direction) of the door beam 3. Note that the door beam 3 defined herein excludes the extension section 3j which protrudes outward from a base section 3n located on the extension of the parallel edges of the door beam 3.

The extension section 3j is a protrusion which protrudes outward from the fundamental cross-section edge 3i and is a section for forming the locating hole 3k on the outside of the fundamental cross-section edge 3i. The extension section 3j is formed to protrude from the lower edge near the front end 3a of the door beam 3.

The locating hole 3k is a hole for positioning the door beam 3 when joining the door beam 3 to the door 2 with spot welding or the like, and is formed at a position close to the tip of the extension section 3j.

As illustrated in FIG. 1, the door lock device mounting hole 3m is a hole for mounting the door lock device 5 on the door beam 3 with a fastening member (not shown) such as a screw, and is formed on the rear end 3b of the concave section 31a. Accordingly, a latch mechanism of the door lock device 5 is provided at a position opposite to the vehicle interior side to overlap with the vehicle interior side of the rear end 3b of the door beam 3, thereby allowing the door beam 3 to reduce collision load applied to the door lock device 5 at vehicle lateral collision.

As illustrated in FIG. 2, the concave section 31a is a section which is formed in the central part in the up-down width direction and in the form of a concave channel when viewed in longitudinal section, and is provided to extend in the longitudinal direction between the convex section 31b and the convex section 31c. The concave section 31a is arranged to allow a face thereof on the vehicle interior side to abut on the surface of the bracket 4, and the joining point 3d is formed on a bottom face of the front end 3a of the door beam 3. The concave section 31a serves a function of reinforcing the door beam 3 because bending in the form of a concave channel causes a ridge line L to be formed.

The convex sections 31b, 31c are sections which are formed up and down next to the concave section 31a and in the form of a convex hill when viewed in longitudinal section, and are provided to extend in the longitudinal direction. The convex sections 31b, 31c serve a function of reinforcing the door beam 3 because bending in the form of a convex hill causes two ridge lines L to be formed up and down, respectively.

The flange sections 31d, 31e are plate-shaped sections which are formed on the upper and lower edges of the convex sections 31b, 31c, respectively, and are provided to extend in the extension direction of the beam body 31. The flange sections 31d, 31e are provided to allow respective faces thereof on the vehicle interior side to abut on the surface of the bracket 4, and the joining points 3c, 3e at the front end 3a of the door beam 3 are allowed to join to the bracket 4. Moreover, the beam body 31 is formed such that the flange sections 31d, 31e, the concave section 31a and the convex sections 31b, 31c constitute a shape in which two hat-shaped sections are consecutively connected when viewed in longitudinal section.

### <<Actions>>

Next, actions of the vehicle door according to the embodiment of the present invention will be described with reference to FIG. 1 and FIG. 2.

For example, when the own vehicle collides with another vehicle or the like to exert bending moment on the door 2 to thereby give a tensile load (indicated by arrow mark A) to the door beam 3, collision load of the tensile load can be avoided from acting on the locating hole 3k because the locating hole 3k is formed in the extension section 3j protruding outward from the fundamental cross-section edge 3i of the door beam 3. Consequently, the door beam 3 makes it possible to suppress a decrease in withstanding impact force even where the locating hole 3k is formed.

Also, the door beam 3 can sufficiently serve as a reinforcing beam member even if made from a metallic plate material, because the concave section 31a and the convex sections 31b, 31c are formed in the extension direction of the door beam 3 to cause a number of ridge lines L to be formed in the extension direction of the door beam 3 to reinforce the door beam 3.

Thus, the vehicle door according to the present invention allows the locating hole 3k to be formed on the outside of the fundamental cross-section edge 3i of the door beam 3, thereby making it possible to suppress a decrease in strength and withstanding impact force even in the presence of the locating hole 3k. Moreover, since the door beam 3 can be easily formed by stamping one rolled steel plate, the structure and manufacturing of the door beam 3 are simplified and thus increases in weight, machining man-hour, machining time and cost can be suppressed.

### MODIFICATION

Note that it goes without saying that the present invention is not limited to the embodiment described above and can be variously altered or modified within the scope of the technical idea and thus the present invention also extends to the altered or modified invention.

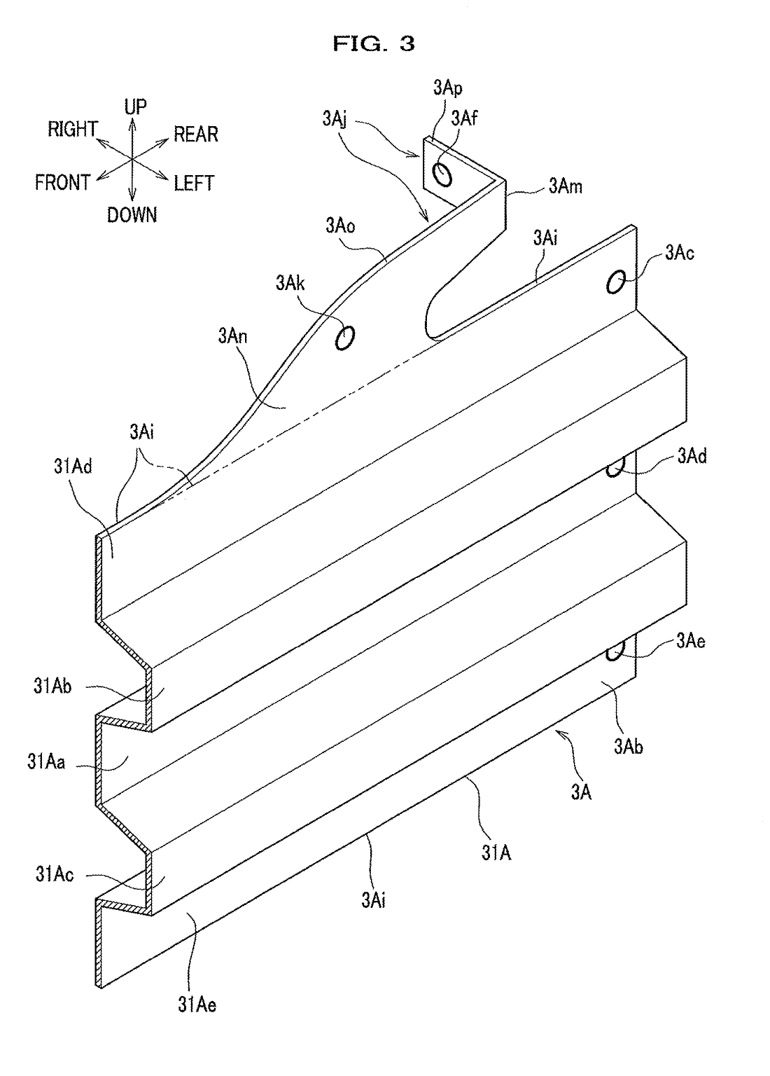

FIG. 3 is an enlarged schematic perspective view of the relevant part of a door beam, illustrating one modification of the vehicle door according to the embodiment of the present invention. FIG. 4 is a view illustrating one modification of the vehicle door according to the embodiment of the present invention, and is an enlarged schematic transverse sectional view of the relevant part of the door beam, illustrating a mounted state of a rear end of the door beam.

In the above embodiment, description has been given of, by way of example as illustrated in FIG. 2, the case where the locating hole 3k is formed in the extension section 3j protruding outward from the edge in the up-down width direction of the door beam 3. But, as long as the locating hole 3k and the extension section 3j are formed on the outside of the fundamental cross-section edge 3i of the door beam 3, shapes and locations thereof are not particularly limited.

As illustrated in FIG. 3, for example, an extension section 3Aj of a door beam 3A may protrude outward from a fundamental cross-section edge 3Ai of a beam body 31A to be formed on the tip of a bend section 3Am which is bent in the thickness direction of a door 2A.

In this case, joining points 3Ac-3Ae are formed on a concave section 31Aa and flange sections 31Ad, 31Ae at a rear end 3Ab of a door beam 3A and joined to the door 2A in the thickness direction of the door 2A (see FIG. 4).

Moreover, the extension section 3Aj includes a base section 3An which extends outward from the fundamental cross-section edge 3Ai, a projection section 3Ao which is formed to extend from the base section 3An to be away from the fundamental cross-section edge 3Ai, the bend section 3Am which is bent in the thickness direction of the door 2A at the tip of the projection section 3Ao, a joining section 3Ap which extends from the bend section 3Am in the thickness direction of the door 2A, a locating hole 3Ak which is formed in the base section 3An, and a second joining point 3Af which is formed in the joining section 3Ap (see FIG. 4).

As illustrated in FIG. 3 and FIG. 4, the base section 3An extends upward from the upper fundamental cross-section edge 3Ai of the beam body 31A and further extends toward the vehicle interior.

The projection section 3Ao extends rearward from the upper side of the base section 3An, and is formed parallel along the upper fundamental cross-section edge 3Ai of the beam body 31A.

The bend section 3Am is bent in the direction of the vehicle interior, at a right angle to the projection section 3Ao extending in the front-rear direction.

As illustrated in FIG. 4, the joining section 3Ap is secured by joining the second joining point 3Af to an inner panel 21A with spot welding, to a beam mounting section 21Aa of the door 2A which is formed at a position facing a front face 10a of a rear pillar 10 forming part of the door opening 1a of the vehicle body 1. Note that the rear pillar 10 is formed by joining a rear pillar outer 11 and a rear pillar inner 12 together in the form of a hollow pillar, and a rear side beam mounting section 21Ab of the inner panel 21A and the rear end 3Ab of the door beam 3A are arranged on the outside of the rear pillar outer 11.

Moreover, the joining points 3Ac, 3Ad, 3Ae are joined with spot welding to the rear side beam mounting section 21Ab of the door 2A which is formed at a position facing a side face 10b of the rear pillar 10, to thereby be secured to the inner panel 21A.

The locating hole 3Ak is used to position the door beam 3A in engagement with a positioning pin not shown in the figure when working on welding to join the joining points 3Ac, 3Ad, 3Ae.

The door beam 3A allows the extension section 3Aj having the locating hole 3Ak and the second joining point 3Af to be formed on the outside of the fundamental cross-section edge 3Ai thereof, thereby making it possible to suppress a decrease in strength and withstanding impact force even in the presence of the locating hole 3Ak and the second joining point 3Af.

### OTHER MODIFICATIONS

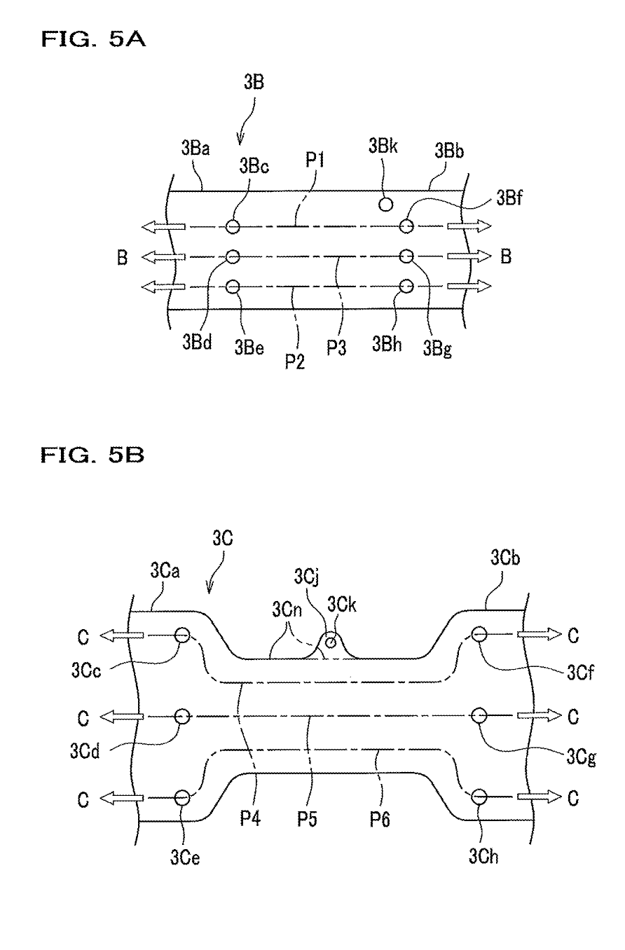

FIGS. 5A and 5B are views illustrating another modification of the vehicle door according to the embodiment of the present invention, in which FIG. 5A is a schematic view of the relevant part illustrating a door beam having a constant width in the up-down direction, and FIG. 5B is a schematic view of the relevant part illustrating a door beam having a wider section and a narrower section in width in the up-down direction.

As illustrated in FIG. 5A, in the case of a door beam 3B having a nearly constant width in the up-down direction, a locating hole 3Bk should be formed on the outside of the outer lines of action P1, P2 in the up-down width direction, of the lines of action P1, P2, P3 of tensile force B which connect joining points 3Bc, 3Bd, 3Be formed on a front end 3Ba of the door beam 3B with joining points 3Bf, 3Bg, 3Bh formed on a rear end 3Bb of the door beam 3B.

Thus, where the door beam 3B is not provided with the extension section 3j (see FIG. 2) described in the above embodiment, the locating hole 3Bk is formed on the outside of the lines of action P1, P2 of tensile force B in the up-down width direction, which connect the joining points 3Bc, 3Be formed on the outer sides in the up-down direction of the door beam 3B with the joining points 3Bf, 3Bh formed on the outer sides in the up-down direction of the door beam 3B, thereby making it possible to provide the locating hole 3Bk at a position unaffected by the tensile force B.

Also, as illustrated in FIG. 5B, in the case of a door beam 3C having a wider section and a narrower section in width in the up-down direction, a locating hole 3Ck should be formed on the outside of the outer lines of action P4, P6 in the up-down width direction, of the lines of action P4, P5, P6 of tensile force C which connect joining points 3Cc, 3Cd, 3Ce formed on the wider section on a front end 3Ca of the door beam 3C with joining points 3Cf, 3Cg, 3Ch formed on the wider section on a rear end 3Cb of the door beam 3C.

Moreover, the locating hole 3Ck may be formed in an extension section 3Cj which is formed to protrude outward from the edge of the narrower section of the door beam 3C, as illustrated in FIG. 5B.

Thus, since the section where the extension section 3Cj is formed lies in the outside of the lines of action P4, P6 of tensile force C in the up-down width direction, which connect the joining points 3Cc, 3Ce formed on the outer sides in the up-down direction of the door beam 3C with the joining points 3Cf, 3Ch formed on the outer sides in the up-down direction of the door beam 3C, the locating hole 3Ck can be provided at a position unaffected by the tensile force C.

In the above embodiment and modifications, description has been given of, by way of example, the case where the joining points 3c-3h, 3Ac-3Ae, 3Bc-3Bh, 3Cc-3Ch of the door beam 3, 3A, 3B, 3C are joined to the door 2, 2A with spot welding. But, as long as the door beam 3, 3A, 3B, 3C can be secured to the door 2, 2A, joining means for the joining points 3c-3h, 3Ac-3Ae, 3Bc-3Bh, 3Cc-3Ch is not particularly limited. The joining means may be, for example, mechanical securing means such as bolts, nuts or rivets, or other welding means.

Also, the door beam 3A described in the above modification is not necessarily provided with the bend section 3Am, the joining section 3Ap and the second joining point 3Af as long as the base section 3An in which the locating hole 3Ak is formed, or the projection section 3Ao is formed.

Even this configuration makes it possible to allow collision load not to act on the locating hole 3Ak.

### REFERENCE SIGNS LIST

1a Door opening
2, 2A Door
3, 3A, 3B, 3C Door beam
3c-3h, 3Ac-3Ae, 3Bc-3Bh, 3Cc-3Ch Joining point
3i, 3Ai Fundamental cross-section edge
3j, 3Aj, 3Cj Extension section
3k, 3Ak, 3Bk, 3Ck Locating hole
3Af Second joining point
3Am Bend section
3An Base section
3Ao Projection section

1. A vehicle door comprising:
a door which opens and closes a door opening in the vehicle; and
a door beam which is provided inside the door, the door beam including:
joining points which are joined to the door;
a fundamental cross-section edge which extends in a direction of extension of the door beam, on the outside of the joining points in a width direction of the door beam;
an extension section which protrudes outward from the fundamental cross-section edge; and
a locating hole which is used for positioning when joining the door beam to the door, wherein
the locating hole is formed in the extension section.

2. The vehicle door according to claim 1, wherein
the joining points are joined to the door in a thickness direction of the door,
the extension section includes a bend section which is bent in the thickness direction of the door, and
the bend section includes a second joining point which is joined to the door in a width direction of the door.

3. The vehicle door according to claim 2, wherein
the extension section includes a base section which extends outward from the fundamental cross-section edge, and a projection section which is formed to extend from the base section to be away from the fundamental cross-section edge, and
the bend section is formed in the projection section.

4. The vehicle door according to claim 3, wherein the locating hole is formed in the base section.
